(19) United States
(12) Patent Application Publication
(10) Pub. No.: US 2013/0209070 A1
(43) Pub. Date: Aug. 15, 2013

(54) System and Method for Creating Composite Video Test Results for Synchronized Playback

(71) Applicants: Alejandro Rivas-Micoud, San Francisco, CA (US); Ariel Rivas-Micoud, Madrid (ES); Francisco Erlich, Madrid (ES); Luis Gonzalez, Madrid (ES)

(72) Inventors: Alejandro Rivas-Micoud, San Francisco, CA (US); Ariel Rivas-Micoud, Madrid (ES); Francisco Erlich, Madrid (ES); Luis Gonzalez, Madrid (ES)

(21) Appl. No.: 13/370,786

(22) Filed: Feb. 10, 2012

(51) Int. Cl. H04N 5/93

(52) U.S. Cl. 386/285; 386/278; 386/E05.028

(57) ABSTRACT

One embodiment of a method for creating composite video test results includes obtaining a screenshot video of a test display, obtaining a camera video of a tester interacting with the test display, and dividing the screenshot video and camera video into segments. A plurality of composite video segments are then created, where each composite video segment is a composite of one of the plurality of camera video segments and one of the plurality of screenshot video segments. The plurality of composite video segments are then combined into a composite video. In one embodiment, audio data of the tester is combined with the composite video to create a composite audiovisual file. The composite video may be played back by a web browser in such a way that a viewer perceives the composite video as two separate videos that are synchronized.

### FIELD OF THE INVENTION

The invention relates to online video recording and playback, and more particularly to a system and method for creating composite video test results for synchronized playback.

### BACKGROUND

Companies conducting marketing and advertising campaigns, market research, or user interface development may wish to study the reactions and interactions of persons in their homes or offices with offline and online content such as websites, advertisements, video or other types of media, prototypes, messaging, and the like. For example, companies may want to test consumers' reactions to advertisements or promotions before formally launching them. Others may want to conduct usability tests of new software or games. Such studies enable companies to develop products that are more suited to their target segments, conduct user experience and usability studies on prototypes and user interfaces, optimize advertisement and media planning, diagnose analytics results, conduct comparisons for branding initiatives, and many other activities that rely on user feedback.

A typical method of conducting such studies is to assign testers to interact with a website or other material and to record their interactions along with the testers' reactions. A tester may use a computer at a testing location local to the test administrator or a computer at a location remote from the test administrator. Such testing typically includes capturing video of the tester's screen during a test. In one example, the video of the tester's screen shows the positions of the cursor/pointer on the screen as the tester navigates a webpage, user interface, or other material, and the changes in the screen as the tester selects interactive elements, fills in information, or plays video or audio files. Such testing also typically includes capturing video and/or audio of the tester. The audio captures comments and opinions of the tester (“thinking aloud”), and the video captures facial expressions, posture, and other non-verbal indications of the tester's reaction to the material being tested.

The test results include the captured audio and video of the tester's computer and screen during the test, the audio and video of the tester (typically captured by a web cam), and may additionally include the tester's answers to specific questions posed after a task has been completed. An analysis of the test results typically involves playing back the video of the tester's screen and the video and audio of the tester. The analysis is more meaningful and it is much easier to decipher and uncover insights when the screen video and tester audio and video are played back at the same time. However, because the screen video and the tester audio and video were captured using different processes and devices, the content from the different sources will not be synchronized during playback. This lack of synchronization makes the analysis of the results very difficult. For example, if the tester audio and the screenshot video are not synchronized and the tester's voice refers to “this” or “that” on the screen without being specific as to what is being referred to, the analyzer may not be able to determine what aspect of the screen image the tester is commenting on. The lack of synchronization implies a significant loss of time and efficiency, especially if test results from a large number of testers are being analyzed.

In addition, it is important for a testing system to be efficient in it use, and as such, a participant in a remote location in order to conduct the test(s) should not have to download a large application or file size, and instead should be able to download a simple applet that takes a minimum amount of time, typically less than one minute. Otherwise, most participants will not wish to be involved in a test or a study that requires them to download a large file size, such as a typical desktop application.

It is also important that the audiovisual files of the test results are of a manageable size for just about any transmission bandwidth to guarantee that the tester does not abandon the test due to excessive uploading time of the results, and that the test results are able to be efficiently downloaded by an entity wishing to view the results.

### SUMMARY

One embodiment of a method for creating composite video test results includes obtaining a screenshot video of a test display, obtaining a camera video of a tester, and dividing the screenshot video and camera video into segments. A plurality of composite video segments are then created, where each composite video segment is a composite of one of the plurality of camera video segments and one of the plurality of screenshot video segments. The plurality of composite video segments are then combined into a composite video. An audio file of the usability tester may be combined with the composite video to create a composite audiovisual file. The composite video may be played back by a web browser in such a way that a viewer perceives the composite video as two separate videos that are synchronized. In one embodiment, the web browser plays back each component of the composite video in separate windows, where one or both of the windows may be moved to a different location on the viewer's screen, resized, or minimized.

Another embodiment of a method for creating composite video test results includes obtaining a camera audiovisual file containing image data and audio data of a tester, obtaining a screenshot video file containing image data of a test display, separating the camera audiovisual file into camera video data and audio data, and dividing the camera video data and the screenshot video data into segments. A plurality of composite video segments is then created, each composite video segment being a composite of one of the plurality of camera video segments and one of the plurality of screenshot video segments. The plurality of composite video segments are combined into a composite video and the audio data is added to the composite video to create a composite audiovisual file.

### BRIEF DESCRIPTION OF THE DRAWINGS

FIG. 1 is a block diagram of a system for implementing one embodiment of the invention;

FIG. 2 is a block diagram of one embodiment of the test administrator of FIG. 1;

FIG. 3 is a diagram of the video compositing process, according to one embodiment of the invention;

FIG. 4 is a flowchart of method steps for creating a composite test results video, according to one embodiment of the invention; and

FIG. 5 is a diagram of a test playback graphical user interface, according to one embodiment of the invention.

### DETAILED DESCRIPTION

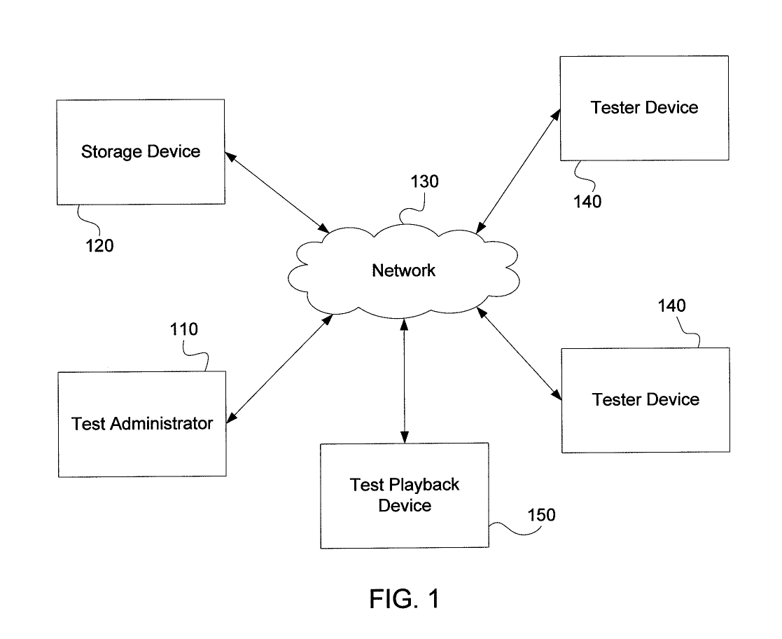

FIG. 1 is a block diagram of a system for implementing one embodiment of the invention. A test administrator 110 is coupled to a network 130. A plurality of tester devices 140 are coupled to network 130 and are capable of communicating with test administrator 110. A storage device 120 is coupled to network 130 and is capable of communicating with test administrator 110. A test playback device 150 is coupled to network 130 and is capable of communicating with test administrator 110 and optionally storage device 120. Network 130 may be a wide area network, a local area network, or a combination, and may include both wired and wireless communication links. In one embodiment, storage device 120 is co-located with test administrator 110 and in other embodiments storage device 120 is located remotely from test administrator 110. In one embodiment, one or more of the plurality of tester devices 140 may be co-located with test administrator 110.

Test administrator 110 administers tests performed by testers using tester devices 140. Tester device 140 may be a desktop or laptop computer, a netbook computer, a tablet computer, a smartphone, or any other type of computing device that includes a display screen. The tests may be tests of websites, webpages, software applications, advertisements, promotions, movie trailers, television pilots, or any other material that a tester is able to interact with via a computing device having a display screen. In one embodiment, test administrator 110 sends a testing software application to each tester device 140, which is then installed on tester device 140. In one embodiment, the testing software application is configured as a plug-in to a web browser application. In another embodiment, the testing software application is a small applet, which checks for camera (webcam) availability and configuration, and if none is available, ends the session, and if a camera is available and configured correctly, proceeds with the testing session. The testing software application is configured to provide instructions to the tester for performing the test, directing him or her to view certain files or go to certain URLs and perform certain tasks, while providing verbal comments. The testing software application is configured to capture video of the tester device's 140 screen and any audio generated by the tester's device 140 during the test and also to control the capture of video and audio of the tester during the test. The video and audio of test device 140 may be in separate files or may be combined in a single audiovisual file. Similarly, the video and audio of the tester may be in separate files or may be combined in a single audiovisual file. The video and audio of the tester may be captured using a camera and microphone built into the tester device 140 or using a camera and microphone coupled to the tester device 140. The testing software application is also configured to send the captured screenshot video and device audio and the audio and video of the tester to test administrator 110. In one embodiment, during the simultaneous recording of the screen activity and the camera's input, the testing software application decreases the size of the resulting audiovisual files by a process of compression and by decreasing the frame rate below twenty-four frames per second. The testing software application sends the reduced audiovisual files to test administrator 110 as the reduced audiovisual files are created. This streaming continues, including after the test is completed, until all of the test results have been sent to test administrator 110, including any answers to any post-test activity questions.

Test playback device 150 may be a desktop or laptop computer, a tablet computer, a smartphone, or any other type of computing device that includes a display screen. A user of test playback device 150 is able to access the results of the tests, which include the screen video and the audio and video of the tester captured during each test.

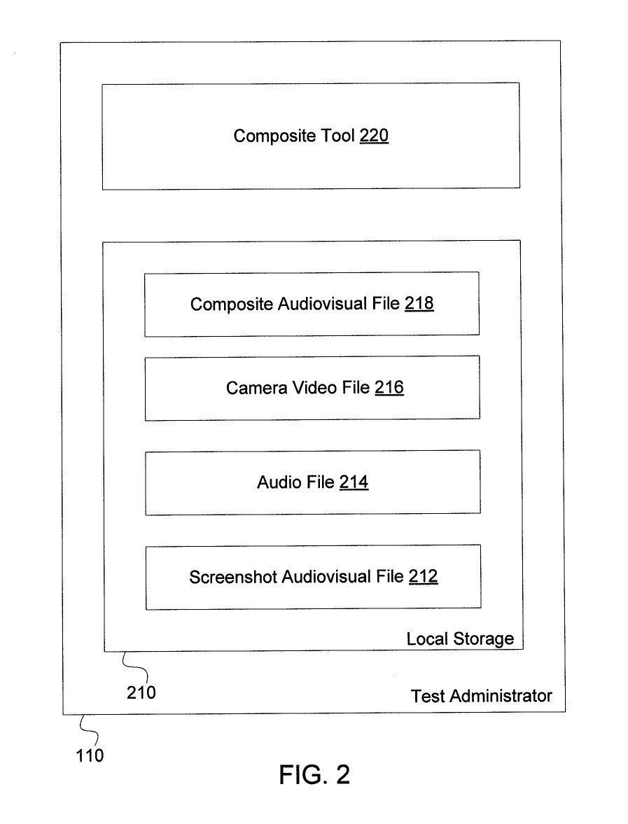

FIG. 2 is a block diagram of one embodiment of test administrator 110 of FIG. 1. Test administrator 110 includes, but is not limited to, a local storage 210 and a composite tool 220. Local storage 210 includes, but is not limited to, a screenshot audiovisual file 212, an audio file 214, a camera video file 216, and a composite audiovisual file 218. Test administrator 110 received screenshot audiovisual file 212, audio file 214, and camera video file 216 from tester device 140. Each of screenshot audiovisual file 212, audio file 214, and camera video file 216 includes metadata that identify the tester device 140 from which that file was received and the test associated with that file. Audio file 214 and camera video file 216 contain audio and video, respectively, of a tester during performance of the test. Screenshot audiovisual file 212 is video of the screen of tester device 140 during performance of the test and any audio generated by tester device 140 during the test. Although only the results of one test received from one tester device 140 are shown in FIG. 2, local storage 210 may store results from a plurality of tests performed by a plurality of users. For example, local storage 210 may store a plurality of results associated with a single test which were received from a plurality of tester devices 140.

Composite tool 220 creates composite audiovisual file 218 by combining screenshot audiovisual file 212, audio file 214, and camera video file 216. In another embodiment, composite tool 220 creates composite audiovisual file 218 using a screenshot audiovisual file and a camera audiovisual file. Each frame of video in composite audiovisual file 218 is a composite comprising one frame of video from screenshot audiovisual file 212 and one frame of video from camera video file 216. Since composite audiovisual file 218 contains a frame-by-frame composite of screenshot audiovisual file 212 and camera video file 216, during playback of composite audiovisual file 218 a viewer will observe a synchronized playback of the screenshot video, the camera video, and any audio.

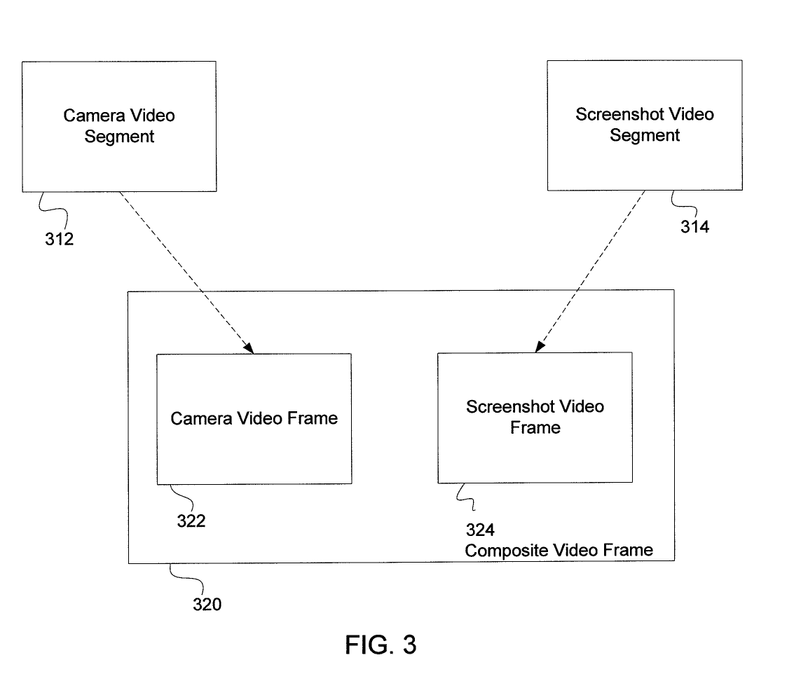

FIG. 3 is a diagram of the video compositing process, according to one embodiment of the invention. Composite tool 220 divides each of camera video file 216 and the video portion of screenshot audiovisual file 212 into segments of equal size. Composite tool 220 inserts a camera video frame 322 from a camera video segment 312 into a composite video frame 320. Composite tool 220 inserts a screenshot video frame 324 from a screenshot video segment 314 into composite video frame 320. In one embodiment, composite tool 220 uses the FFmpeg tool to create each composite video frame 320.

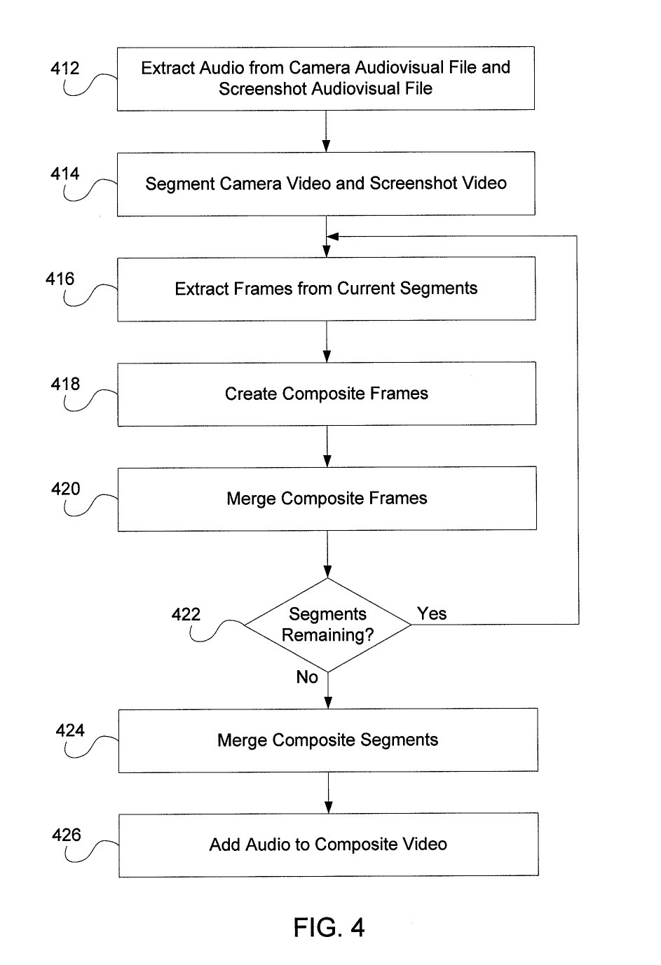

FIG. 4 is a flowchart of method steps for creating a composite user test results video, according to one embodiment of the invention. In step 412, composite tool 220 extracts the audio from a camera audiovisual file and any audio from a screenshot audiovisual file. If a separate audio files and video files are stored in local storage 210 for the test, step 412 is skipped. In step 414, composite tool 220 divides the camera video into segments and divides the screenshot video into segments of the same size. In one embodiment, composite tool 220 divides both videos into a series of one-minute segments. The number of total segments for a particular video will depend on the length of each segment and the total length of the particular videos to be composited. Composite tool 220 determines which of the camera video or screenshot video is the shortest, and sets the duration of that shortest video as the duration of the composite video. The remaining images at the end of the longer video are ignored during the compositing process.

In step 416, composite tool 220 extracts frames from the first segment of screenshot video and extracts frames from the first segment of camera video. In step 418, composite tool 220 creates a set of composite frames. Each composite frame is a single video frame created by merging one frame from the screenshot video and one frame from the camera video. In one embodiment, composite tool 220 uses the FFmpeg tool to create each composite frame. In step 420, composite tool 220 concatenates the composite frames for the current segments of screenshot video and camera video to create a segment of composite video.

In step 422, composite tool 220 determines whether any segments of screenshot video and camera video remain to be composited. If so, the method of FIG. 4 continues with step 416 for the next camera video segment and the next screenshot video segment. If all segments of screenshot video and camera video have been composited, then the method continues with step 424. In step 424, composite tool 220 merges the segments of composite video into a complete composite video. In one embodiment, composite tool 220 uses the MEncoder tool to merge the segments of composite video into a final composite video. In step 426, composite tool 220 adds the extracted audio data to the composite video to create a composite audiovisual file. If step 412 was not performed, then in step 426 composite tool 220 adds the separate audio file(s) to the composite video to create a composite audiovisual file. Composite tool 220 also adds the time stamp of the camera video to the composite audiovisual file.

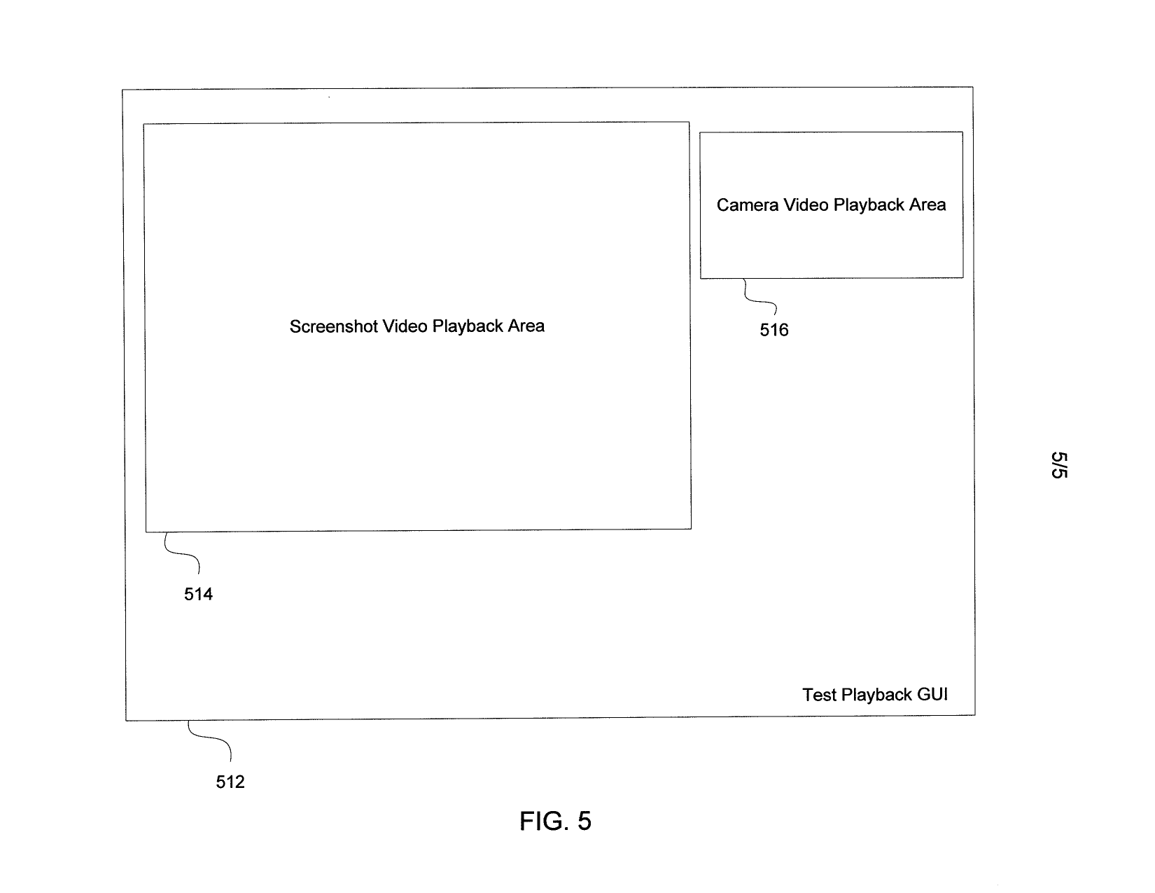

FIG. 5 is a diagram of a test playback graphical user interface (GUI), according to one embodiment of the invention. A test playback GUI 512 is typically presented to a user via a web browser application running on test playback device 150. Test playback GUI 512 includes, but is not limited to, a screenshot video playback area 514 and a camera video playback area 516. When a user requests playback of a test, test administrator 110 will send the composite audiovisual file associated with that test to test playback device 150. In another embodiment, the composite audiovisual file is sent from storage device 120 to test playback device 150. When the web browser on test playback device 150 receives the composite audiovisual file, the web browser detects that the file is a composite of two videos and that the two videos are to be presented to the user in separate areas of the GUI according to techniques that are well-known in the art. In addition, the web browser detects that the audio portion of the composite audiovisual file should be played when the video portions of the composite audiovisual file are being played.

In the FIG. 5 embodiment, screenshot video playback area 514 is on the left side of test playback GUI 512 and camera video playback area 516 is a smaller portion of the area of test playback GUI 512 and is positioned on the right. In other embodiments, the positions and relative sizes of the two playback areas can be switched, or the user of test playback device 150 may be enabled to change the positions of one or both of the two playback areas within test playback GUI 512. Because screenshot video playback area 514 and camera video playback area 516 present portions of the composite audiovisual file, the presentations will be synchronized in time.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A method comprising:
obtaining a camera video containing images of a person viewing images on a display device;
obtaining a screenshot video containing the images on the display device;
dividing the camera video into a plurality of camera video segments;
dividing the screenshot video into a plurality of screenshot video segments, each of the plurality of screenshot video segments having the same duration as each of the plurality of camera video segments;
creating a plurality of composite video segments, each composite video segment being a composite of one of the plurality of camera video segments and one of the plurality of screenshot video segments; and
combining the plurality of composite video segments into a composite video.

2. The method of claim 1, further comprising:
obtaining an audio file associated with the camera video; and
combining the audio file with the composite video to produce a composite audiovisual file.

3. The method of claim 1, further comprising:
obtaining an audio file associated with the screenshot video; and
combining the audio file with the composite video to produce a composite audiovisual file.

4. The method of claim 1, wherein each composite video segment includes a plurality of composite video frames, each of the plurality of composite video frames being a composite of one frame of the camera video and one frame of the screenshot video.

5. The method of claim 1, further comprising sending the composite video to a device for playback by a web browser.

6. The method of claim 1, wherein the composite video is configured to be displayed by a display device such that the composite video appears to be two separate videos.

7. A method comprising:
obtaining a camera audiovisual file containing image data and audio data of a person viewing images on a display device;
obtaining a screenshot video file containing the images on the display device;
separating the camera audiovisual file into camera video data and audio data;
dividing the camera video data into a plurality of camera video segments;
dividing the screenshot video data into a plurality of screenshot video segments, each of the plurality of screenshot video segments having the same duration as each of the plurality of camera video segments;
creating a plurality of composite video segments, each composite video segment being a composite of one of the plurality of camera video segments and one of the plurality of screenshot video segments;
combining the plurality of composite video segments into a composite video; and
combining the composite video and the audio data to create a composite audiovisual file.

8. The method of claim 7, further comprising:
obtaining an audio file associated with the screenshot video; and
combining the audio file with the composite video to produce a composite audiovisual file.

9. The method of claim 7, wherein each composite video segment includes a plurality of composite video frames, each of the plurality of composite video frames being a composite of one frame of the camera video and one frame of the screenshot video.

10. The method of claim 7, further comprising sending the composite audiovisual file to a device for playback by a web browser.

11. The method of claim 7, wherein the composite video is configured to be displayed by a display device such that the composite video appears to be two separate videos.
